(19) United States
(12) Patent Application Publication
(10) Pub. No.: US 2014/0176756 A1
(43) Pub. Date: Jun. 26, 2014

(54) CAMERA APPRATUS AND METHOD TAKING PICTURES OF THE CAMERA APPARATUS

(71) Applicant: Samsung Electronics Co., Ltd., Suwon-si (KR)

(72) Inventor: Sung-Jin YOON, Suwon-si (KR)

(73) Assignee: Samsung Electronics Co., Ltd., Suwon-si (KR)

(21) Appl. No.: 14/140,242

(22) Filed: Dec. 24, 2013

(30) Foreign Application Priority Data
Dec. 24, 2012 (KR) 10-2012-0152450

(51) Int. Cl. H04N 5/232

(52) U.S. Cl. CPC H04N 5/23229
USPC 348/222.1

(57) ABSTRACT

A camera apparatus for capturing a picture image or a dynamic image of a constant composition without relation to a slope of a camera apparatus and a capturing method thereof are provided. The capturing method includes converting an image input through a lens into at least one of a picture image and a dynamic image, determining whether an operation mode of the camera apparatus corresponds to a fixed composition mode, and cropping at least a part of the at least one of the picture image and dynamic image having a preset composition and storing the least a part of the at least one of the picture image and the dynamic image if the operation mode corresponds to the fixed composition mode.

### PRIORITY

This application claims the benefit under 35 U.S.C. §119(a) of a Korean patent application filed on Dec. 24, 2012 in the Korean Intellectual Property Office and assigned Serial No. 10-2012-0152450, the entire disclosure of which is hereby incorporated by reference.

### BACKGROUND OF THE INVENTION

1. Field of the Invention

The present invention relates to a camera apparatus. More particularly, the present invention relates to a camera apparatus capable of capturing a picture image or a dynamic image (e.g., a video) of a constant composition without relation to a slope of a camera apparatus and a capturing method thereof.

2. Description of the Related Art

A user often encounters the experience of the user's hand shaking at the moment of capturing a picture while holding a camera apparatus. An image captured by the camera apparatus may be blurred because of the hand shaking described above. In addition, adjusting the focus of the camera apparatus may be difficult when the user desires to capture a picture with a zoom of high magnification. Therefore, current camera apparatuses tend to add a hand shaking compensation system.

According to the related art, a hand shaking compensation function relatively clearly compensates for shaking or blurred image. However, such a function does not compensate for composition of an image. When the camera apparatus is slanted to the left or the right by hand shaking or the like, a picture image captured by the camera apparatus is also slanted to left or right in comparison with the case in which the camera apparatus is parallel to the ground. For example, it becomes impossible for the user to capture a picture image with the composition desired by the user because of the slanting of the camera apparatus.

Therefore, a need exists for a method and camera apparatus capable of shooting a picture image or a dynamic image of a constant composition without a slope of a camera apparatus.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention to address at least the above-mentioned problems and/or disadvantages and to provide at least the advantages described below. Accordingly, an aspect of the present invention is to provide a camera apparatus capable of capturing a picture image or a dynamic image of a constant composition without a slope of a camera apparatus and a capturing method thereof.

In accordance with an aspect of the present invention, a camera apparatus is provided. The apparatus includes, a camera configured to receive an image input through a lens; an image processor configured to convert the image into at least one of a picture image and a dynamic image; and a controller configured to: determine whether an operation mode of the camera apparatus corresponds to a fixed composition mode, if the operation mode corresponds to the fixed composition mode, control the image processor to crop at least a part of the at least one of the picture image and the dynamic image so that the at least a part has a preset composition, and control the image processor to store the at least a part of the at least one of the picture image and the dynamic image.

In accordance with another aspect of the present invention, a capturing method of a camera apparatus is provided. The method includes, converting an image input through a lens into at least one of a picture image and a dynamic image; determining whether an operation mode of the camera apparatus corresponds to a fixed composition mode; if the operation mode corresponds to the fixed composition mode, cropping at least a part of the at least one of the picture image and the dynamic image so that the at least a part has a preset composition; and storing the least a part of the least one of the picture image and the dynamic image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 is a block diagram illustrating a construction of a camera apparatus according to an exemplary embodiment of the present invention;

FIG. 2 is a flowchart illustrating a capturing method of a camera apparatus such as, for example, the capture apparatus illustrated in FIG. 1 according to an exemplary embodiment of the present invention;

FIG. 3 is a flowchart illustrating a capture method when a camera apparatus such as, for example, the capture apparatus illustrated in FIG. 1 is in a fixed composition mode according to an exemplary embodiment of the present invention;

FIGS. 4A to 4C are views illustrating examples of a size of a captured picture image when a camera apparatus such as, for example, the capture apparatus illustrated in FIG. 1 is in a fixed composition mode and a non-fixed composition mode according to an exemplary embodiment of the present invention;

FIGS. 5A to 5C are views illustrating examples of a screen displayed by a display unit when a camera apparatus included in a mobile communication terminal is in a fixed composition mode according to an exemplary embodiment of the present invention;

FIGS. 6A to 6C are views illustrating examples of a picture image captured when a camera apparatus such as, for example, the camera apparatus illustrated in FIG. 1 is in a non-fixed composition mode and a fixed composition mode according to an exemplary embodiment of the present invention; and

FIGS. 7A to 7C are views illustrating other examples of a picture image captured when a camera apparatus such as, for example, the camera apparatus illustrated in FIG. 1 is in a non-fixed composition mode and a fixed composition mode according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to exemplary embodiments of the present invention, a camera apparatus may be included mobile devices such as a cellular phone, a personal digital assistant (PDA), a digital camera, a portable game console, an MP3 player, a Portable/Personal Multimedia Player (PMP), a handheld e-book, a portable lap-top Personal Computer (PC), a tablet PC, a Global Positioning System (GPS) navigation, and the like capable of wireless communication or network communication consistent with that disclosed herein.

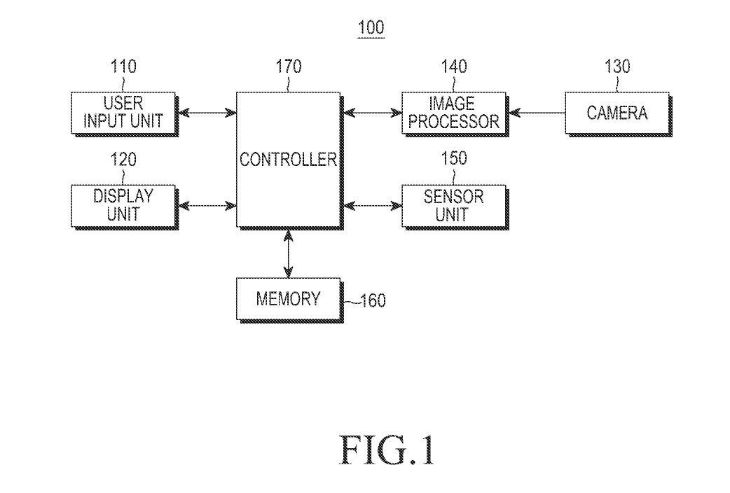

FIG. 1 is a block diagram illustrating a construction of a camera apparatus according to an exemplary embodiment of the present invention.

Referring to FIG. 1, a camera apparatus 100 includes a camera 130, an image processor 140, a sensor unit 150, and a controller 170. The camera apparatus 100 may further include a user input unit 110, a display unit 120, and a memory 160.

The user input unit 110 receives a user input which is made (e.g., input) by a user. The user input unit 110 may include at least one button for receiving the user input. The user input unit 110 according to an exemplary embodiment of the present invention may receive a user input for operating the camera 130. Further, the user input unit 110 may receive a user input for setting a fixed composition mode optionally determined by the user.

According to exemplary embodiments of the present invention, a “fixed composition mode” indicates a capturing mode in which a picture image or a dynamic image (e.g., a video) generated through the image processor 140 have a constant composition regardless of the slope of the camera apparatus 100. For example, when the fixed composition mode has been set, the camera apparatus 100 according to exemplary embodiments of the present invention may generate a picture image or a dynamic image of a constant composition regardless of a change in the slope of the camera apparatus 100 or the camera 130. For example, when the fixed composition mode has been set, a composition of a picture image captured when the slope of the camera apparatus 100 is 0° is substantially identical to a composition of a picture image captured when the slope of the camera 100 is 45°.

In addition, for convenience of the description, capturing modes having compositions other than the fixed composition mode are hereinafter referred to as a “non-fixed composition mode”.

The user input unit 110 according to exemplary embodiments of the present invention may receive not only a user input for setting the fixed composition mode but also a desired composition, for example, an angle of a picture image or a dynamic image, as a “composition setting value”, from a user. For example, if it is assumed that a composition of a picture image desired by a user is slanted by 10° with respect to the ground, then the user input unit 110 may receive “10°” as one of setting values for setting the fixed composition mode (e.g., the composition setting value), from the user.

The display unit 120 displays various data stored in the camera apparatus 100. According to exemplary embodiments of the present invention, the display unit 120 may display an image which is being input through the camera 130 or may display a picture image or a dynamic image captured by the camera 130 and stored in the memory 160.

The display unit 120 according to exemplary embodiments of the present invention may display a user interface for setting the camera apparatus 100 to the fixed composition mode. The display unit 120 may display a user interface allowing the user to easily set a setting value desired to set the fixed composition mode under the control of the controller 170. Further, the display unit 120 may display a picture image or a dynamic image, which can be captured according to the setting value, as a preview, under the control of the controller 170. For example, if it is assumed that the user has input “10°” as a setting value for the fixed composition mode (e.g., a composition setting value) then, the display unit 120 may previously show a picture image that may be captured according to an angle input by the user, by displaying an image input through the camera 130 after rotating the image by 10°.

In addition, the display unit 120 may display a picture image or a dynamic image which has been captured according to the fixed composition mode and stored in the memory 160.

The camera 130 includes at least one lens (not shown) and receives an image. For example, the camera may receive the image by receiving a light input through the lens.

The image processor 140 generates a picture image or a dynamic image by processing an image input through the camera 130, converting the image into the picture image or dynamic image, and then storing the converted picture image or dynamic image in the memory 160. Hereinafter, for convenience of the description, a description related to capturing of a picture image will be made.

The image processor 140 differently processes an image between when the camera apparatus 100 is in the fixed composition mode and when the camera apparatus 100 is in the non-fixed composition mode, under the control of the controller 170.

When the camera apparatus 100 is in the non-fixed composition mode, the image processor 140 converts an image input through the camera 130 into a picture image or a dynamic image. For example, the image processor 140 converts an image input through the camera 130 into a picture image or a dynamic image without any change. In this event, the image processor 140 may convert an image into an image file having an extension, such as a Joint Photography Experts Group (JPEG), Bitmap (BMP), Graphics Interchange Format (GIF), Tagged Image File Format (TIFF), Adobe Photoshop file format (PSD), RAW, CR2, and the like, or into a dynamic image file having an extension, such as WMV, MOV, MKV, MPG, MP4, AV1, and the like.

When the camera apparatus 100 is in the fixed composition mode, the image processor 140 crops at least a part of an image transmitted through the camera 130 according to a preset composition and stores said at least a part of the image in the memory 160, thereby converting said at least a part of the image into a picture image or a dynamic image. That is, in the fixed composition mode, the camera apparatus 100 may capture a picture image or a dynamic image of a constant composition regardless of a slope of the camera apparatus 100.

For example, if it is assumed that the camera apparatus 100 has been set as such that the camera apparatus 100 is in a fixed composition mode and the composition of a picture image in the fixed composition mode is required to be in a state in which the picture image is slanted by 15° in a counterclockwise direction with respect to the ground. Then the image processor 140 converts at least a part of the image slanted by 15° in a counterclockwise direction with respect to the ground, among images transmitted from the camera 130, into a picture image or a dynamic image. In this event, the image processor 140 processes the image transmitted through the camera 130 so that the image has a preset composition with a setting value in the fixed composition mode regardless of the slope of the camera apparatus 100.

According to an exemplary embodiment of the present invention, the image processor 140 may correct the composition of the image by rotating an image, which has been captured in a state in which the image has been slanted by a slope of the camera apparatus 100 measured by the sensor unit 150, by the slope of the camera apparatus 100 in a reverse direction. For example, when it is assumed that the camera apparatus 100 is slanted by 40° in a clockwise direction with respect to the ground by the sensor unit 150, the image processor 140 may correct the composition of the picture image by rotating a picture image captured by the camera apparatus 100 by 40° in a counterclockwise direction.

In addition, the image processor 140 according to an exemplary embodiment of the present invention may adjust a size of a picture image or a dynamic image depending on an operating mode of the camera apparatus 100. For example, the image processor 140 may generate a picture image having a size of “3264×2448 pixels” in the case in which the camera apparatus 100 operates in the non-fixed composition mode, and may generate a picture image having a size of “2048×1536 pixels” in the case in which the camera apparatus 100 operates in the fixed composition mode.

The sensor unit 150 measures a slope of the camera apparatus 100. The sensor unit 150 may include a gyro sensor (not shown), an acceleration sensor (not shown), the like, or any combination thereof, in order to measure the slope of the camera apparatus 100. The sensor unit 150 may measure a slanted angle and a slanted direction (e.g., a clockwise direction or a counterclockwise direction) of the camera apparatus 100 with respect to the ground, and the like, and may transmit the measuring values to the controller 170.

The memory 160 stores various data for controlling operations of the camera apparatus 100. The memory 160 according to the exemplary embodiment of the present invention may store a picture image or a dynamic image captured according to the fixed composition mode.

The controller 170 controls various operations of the camera apparatus 100. The controller 170 according to the exemplary embodiment of the present invention controls the camera apparatus 100 while distinguishing between when the camera apparatus 100 is in the fixed composition mode and when the camera apparatus 100 is in the non-fixed composition mode, so as to cause the camera apparatus 100 to perform operations according to the modes, respectively.

The controller 170 according to the exemplary embodiment of the present invention may determine whether a user input for operating the camera 130 has been received through the user input unit 110. When the user input for operating the camera 130 has not been received, the controller 170 may control the camera apparatus 100 to maintain a standby mode.

When the user input for operating the camera 130 has been received, the controller 170 may determine whether the camera apparatus 100 is in the fixed composition mode. When the camera apparatus 100 is not in the fixed composition mode (e.g., when the camera apparatus 100 is in the non-fixed composition mode), the controller 170 controls the camera apparatus 100 to perform a capturing operation according to the non-fixed composition mode. As described above, in the non-fixed composition mode, the image processor 140 converts an image input through the camera 130 into a picture image or a dynamic image without any change. For example, a composition of a picture image or a dynamic image is changed according to the slope of the camera apparatus 100.

When the camera apparatus 100 is in the fixed composition mode, the controller 170 identifies a composition setting value input through the user input unit 110 or pre-stored in the memory 160. The controller 170 receives a current slope of the camera apparatus 100 from the sensor unit 150 in real time, and controls the image processor 140 to generate a picture image or a dynamic image while applying a composition setting value in the received current slope of the camera apparatus 100 to the control.

For example, it is assumed that the composition setting value implies horizontal with respect to the ground (e.g., the composition setting value is 0° with respect to the ground). If the camera apparatus 100 is in a state in which the camera apparatus 100 is slanted by 30° in the counterclockwise direction with respect to the current ground, an image transmitted from the camera 130 to the image processor 140 also has a composition slanted by 30° in the counterclockwise direction with respect to the current ground. The controller 170 receives a slanted angle and a slanted direction of the camera apparatus 100 through the sensor unit 150. As a result, the controller 170 identifies (e.g., determines) that the camera apparatus 100 has been slanted by 30° in the counterclockwise direction. The controller 170 controls the image processor 140 to crop a part, which is parallel to the ground, in an image slanted by an angle of 30° in the counterclockwise direction, so as to cause the image processor 140 to generate a picture image or a dynamic image reflecting the composition setting value.

According to an exemplary embodiment of the present invention, when the camera apparatus 100 is in the fixed composition mode, the controller 170 may control the image processor 140 to correct an image, which has been captured in a state in which the image is slanted by a slope of the camera apparatus 100 measured through the sensor unit 150, by rotating the image in a reverse direction by the slope of the camera apparatus 100. Further, the controller 170 may control the image processor 140 to rotate and store the image captured in the state of being slanted by the slope of the camera apparatus 100 so that the slanted image may have a composition setting value. For example, when a current slope of the camera apparatus 100 is 30° in the clockwise direction with respect to the ground, the controller 170 may control the image processor 140 to rotate an image transmitted from the camera 130 by 30° in the counterclockwise direction. Moreover, if it is assumed that the composition setting value is 15° in the clockwise direction with respect to the ground and that the current slope of the camera apparatus 100 is 55° in the clockwise direction with respect to the ground. Then the controller 170 may control the image processor 140 to rotate an image, which is slanted by 55° in the clockwise direction with respect to the ground, by 40° in the counterclockwise direction.

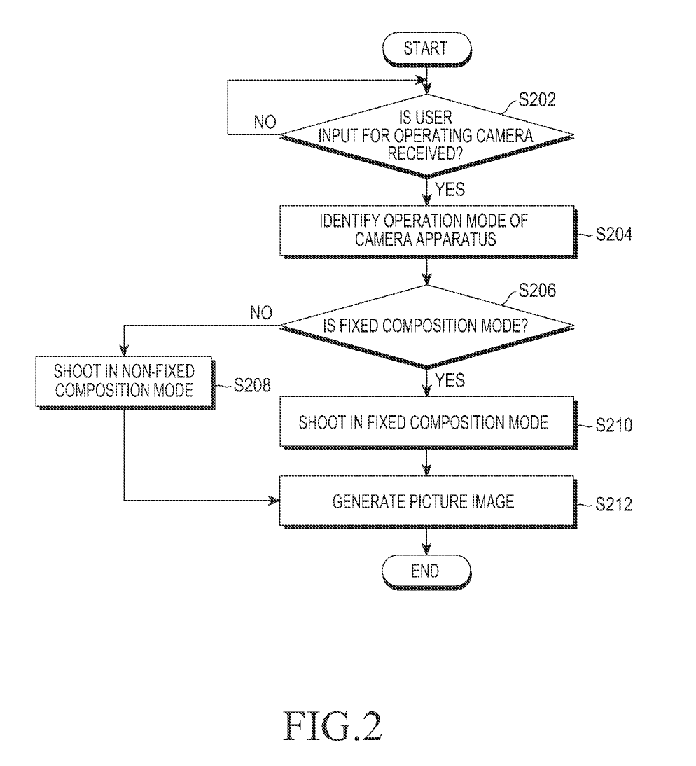

FIG. 2 is a flowchart illustrating a capturing method of a camera apparatus such as, for example, the capture apparatus illustrated in FIG. 1 according to an exemplary embodiment of the present invention.

Referring to FIG. 2, the controller 170 of the camera apparatus 100 determines whether a user input for operating the camera 130 is received through the user input unit 110 in step S202. As a result of the determination in step S202, when the user input for operating the camera 130 has not been received in step S202, the controller 170 may control the camera apparatus 100 to maintain a standby mode without performing a particular operation. For example, the controller 170 may continue to poll for receipt of user input for operating the camera 130.

In contrast, as a result of the determination in step S202, when the user input for operating the camera 130 has been received in step S202, the controller 170 proceeds to step S204 in which the controller 170 identifies an operation mode of the camera apparatus 100.

In step S206, the controller 170 determines whether the operation mode is a fixed composition mode in step S206.

When the controller 170 determines that the camera apparatus 100 is in the fixed composition mode in step S206, the controller proceeds to step S210 in which the controller 170 controls the camera apparatus 100 to capture an image in the fixed composition mode. In the fixed composition mode, the controller 170 may control the image processor 140 to cause a picture image or a dynamic image to have a constant composition regardless of the composition of an image input through the camera 130.

In contrast, when the controller 170 determines that the camera apparatus 100 is not in the fixed composition mode in step S206, the controller 170 controls the camera apparatus 100 to capture an image in the non-fixed composition mode in step S208. In the non-fixed composition mode, the controller 170 may control the image processor 140 to generate a picture image or a dynamic image having a composition which is identical to a composition of an image input through the camera 130.

As described above, the camera apparatus 100 performs a capturing operation according to the fixed composition mode or the non-fixed composition mode. In step S212, the image processor 140 generates a picture image or a dynamic image according to the capturing operation. According to the exemplary embodiment of the present invention, the picture image or the dynamic image generated in step S212 may be stored in the memory 160.

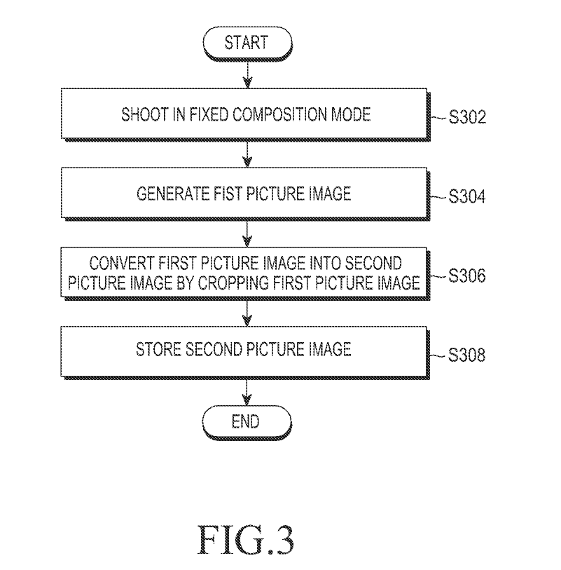

FIG. 3 is a flowchart illustrating a capturing method when a camera apparatus such as, for example, the capture apparatus illustrated in FIG. 1 is in a fixed composition mode according to an exemplary embodiment of the present invention.

Referring to FIG. 3, the camera apparatus 100 is assumed to be slanted by 30° in a clockwise direction with respect to the ground and a composition setting value according to the fixed composition mode is assumed to be slanted by 5° in the clockwise direction with respect to the ground.

When the camera apparatus is in the fixed composition mode, the camera 130 performs a capturing operation in step S302. In step S302, the camera 130 receives light (e.g., an image) input through a lens and transmits the image to the image processor 140. The image processor 140 converts the image into a picture image or a dynamic image. In the exemplary embodiment of the present invention, the image processor 140 is assumed to convert an image transmitted from the camera 130 into a picture image.

Thereafter, the image processor 140 first generates a picture image (e.g., a first picture image) reflecting a current slope of the camera apparatus 100, in step S304.

The first picture image corresponds to a picture image to which a composition setting value is not applied. The first picture image of FIG. 3 has a composition slanted by 30° in the clockwise direction with respect to the ground, similar to the slant of the camera apparatus 100. For example, the image processor 140 may generate the first picture image having a composition which is identical to a composition captured in the non-fixed composition mode. According to the exemplary embodiment of the present invention, the first picture image may be temporarily stored in the memory 160.

According to the exemplary embodiment of the present invention, the first picture image is assumed to correspond to a picture image which is identical to a picture image captured in the non-fixed composition mode. Even in the fixed composition mode, an image input through a lens of the camera 130 is identical to a picture image captured in the non-fixed mode. Therefore, the image processor 140 may generate the image input through the lens of the camera 130 as the first picture image without any change.

In step S306, the image processor 140 converts the first picture image into a second picture image by cropping the first picture image. According to the exemplary embodiment of the present invention, the second picture image is at least a part of the first picture image. Therefore, the image processor 140 may obtain an image, which is obtained by applying a composition setting value to the first picture image (e.g., the second picture image), by cropping the first picture image. Therefore, the controller 170 may determine a part which should be cropped from the first picture image (e.g., data which should be stored as the second picture image), based on a rotation angle of the camera apparatus 100 detected by the sensor 150. Moreover, the image processor 140 generates the second picture image by cropping the part which should be cropped from the first picture image.

For example, a second picture image having a horizontal composition without relation to a slope of the camera apparatus 100 by the fixed composition mode may be assumed to be generated and the second picture image has a size of “2048×1536 pixels”. Further, the camera apparatus 100 may be assumed to be in a state of being slanted by 45°. Because the camera apparatus 100 is slanted by 45°, the first picture image generated by the image processor 140 also may be in a state of being slanted by 45° in the horizontal composition.

The image processor 140 may generate the second picture image by deleting the remaining part except for a rectangular image, which has a horizontal composition and a size of “2048×1536 pixels”, in the first picture image.

When the second picture image is generated as described above, the controller 170 may store the second picture image in the memory 160 in step S308.

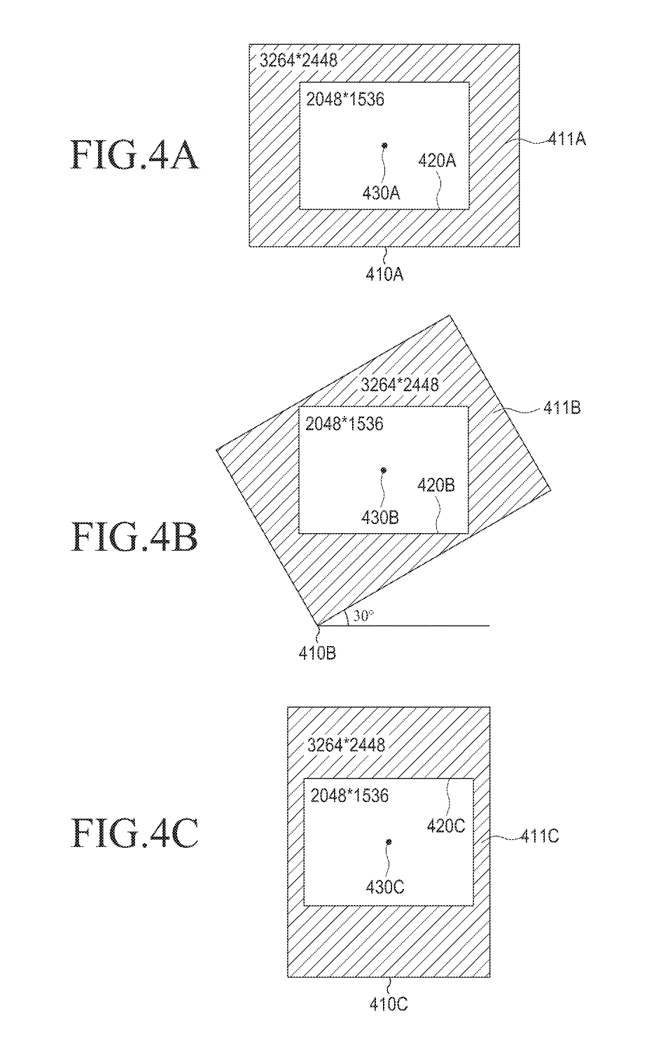

FIGS. 4A to 4C are views illustrating examples of a size of a picture image captured when a camera apparatus such as, for example, the camera apparatus illustrated in FIG. 1 is in a fixed composition mode and a non-fixed composition mode according to an exemplary embodiment of the present invention. Hereinafter, a picture image captured when the camera apparatus 100 is in the non-fixed composition mode is referred to as “a first picture image”, and a picture image captured when the camera apparatus 100 is in the fixed composition mode is referred to as “a second picture image”.

Referring to FIG. 4A, a first picture image 410A and a second picture image 420A are illustrated in a state in which the camera apparatus 100 is horizontal (e.g., in a state in which the camera apparatus 100 is slanted by 0°).

Referring to FIG. 4B, a first picture image 410B and a second picture image 420B are illustrated in a state in which the camera apparatus 100 is slanted by 30° in the counterclockwise direction with respect to the ground.

Referring to FIG. 4C, a first picture image 410C and a second picture image 420C are illustrated in a state in which the camera apparatus 100 is vertical (e.g., in a state in which the camera apparatus is slanted by 90°).

As shown in FIGS. 4A to 4C, while compositions of the first picture images 410A, 410B, and 410C change according to the slope of the camera apparatus 100, all compositions of the second picture images 420A, 420B, and 420C are constant. Further, according to the exemplary embodiment, the second picture images 420A, 420B, and 420C may be rectangular images, each having a size preset by the controller 170 (e.g., a size of “2048×1536 pixels” in FIGS. 4A to 4C), with central points 430A, 430B, and 430C of the first picture images 410A, 410B, and 410C as a center thereof. As described above, the image processor 140 may generate the second picture images 420A, 420B, and 420C by cropping only “2048×1536 pixels” among the first picture images 410A, 410B, and 410C of “3246×2448 pixels”.

In addition, according to the exemplary embodiment, remaining parts 411A, 411B, and 411C except for the second images 420A, 420B, and 420C among the first picture images 410A, 410B, and 410C may be not stored in the memory 160 and may be deleted in real time.

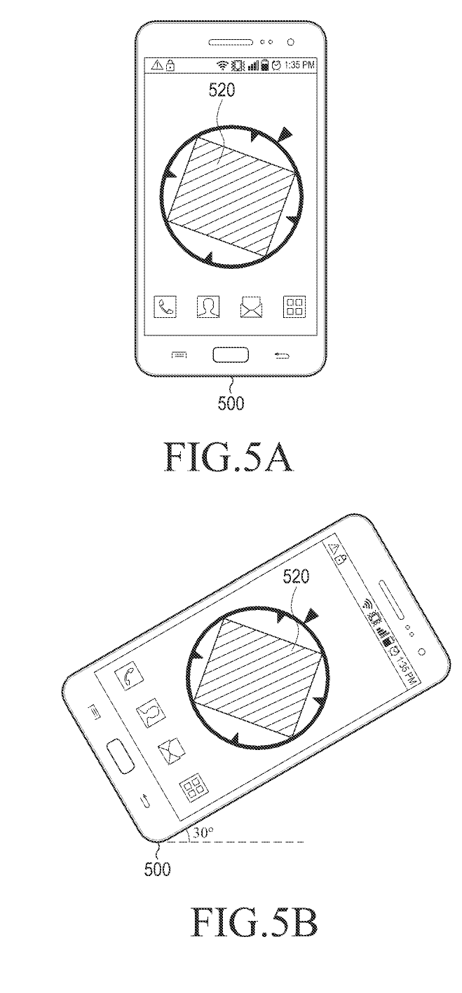

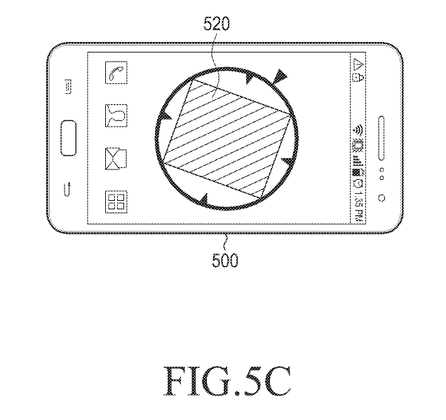

FIGS. 5A to 5C are views illustrating examples of a screen displayed by a display unit when a camera apparatus included in a mobile communication terminal is in a fixed composition mode according to an exemplary embodiment of the present invention.

Referring to FIG. 5A, execution of a fixed composition mode by the camera apparatus 100 is illustrated in a state in which a mobile communication terminal 500 is horizontal (e.g., in a state in which the camera apparatus 100 is slanted by 0°).

Referring to FIG. 5B, execution of a fixed composition mode by the camera apparatus 100 is illustrated in a state in which a mobile communication terminal 500 is slanted by 30° in a counterclockwise direction with respect to the ground.

Referring to FIG. 5C, execution of a fixed composition mode by the camera apparatus 100 is illustrated in a state in which a mobile communication terminal 500 is vertical (e.g., in a state in which the camera apparatus 100 is slanted by 90° in clockwise direction with respect to the ground).

As illustrated in FIGS. 5A to 5C, all capturing compositions 520 of the camera apparatus 100 to which the fixed composition mode is applied are constant without relation to the slope of the mobile communication terminal 500. Therefore, the camera apparatuses 100 of FIGS. 5A to 5C may generate picture images having the same capturing composition 520.

As shown in FIGS. 5A to 5C, when the mobile communication terminal 500 rotates, the camera apparatus 100 included in the mobile communication terminal 500 also rotates. However, all picture images generated by the camera apparatus 100 may have constant compositions.

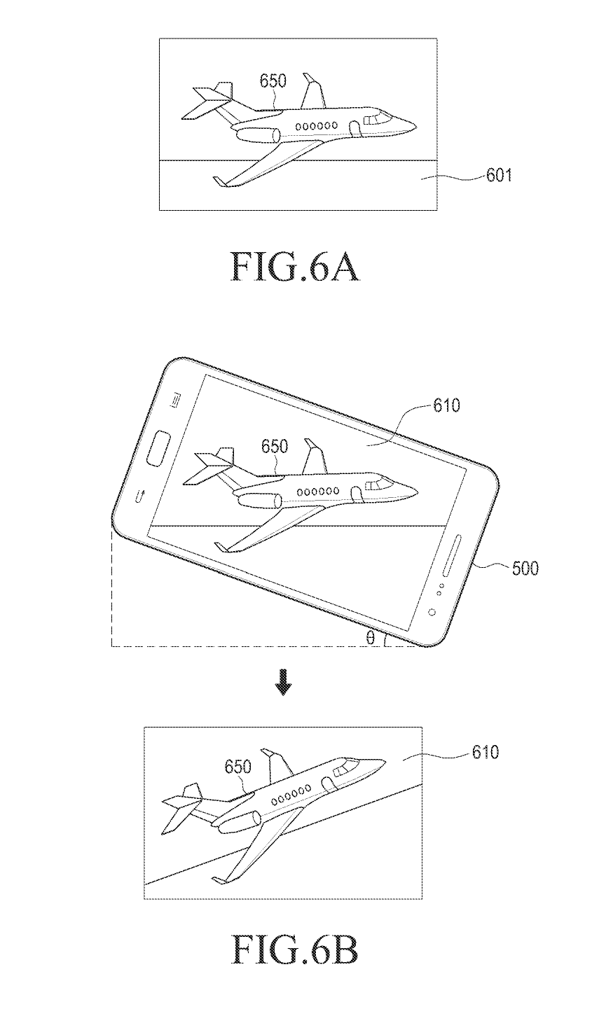

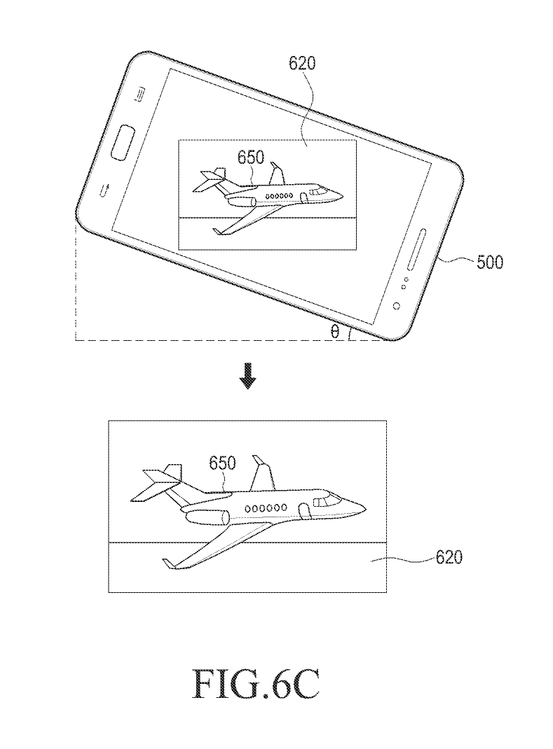

FIGS. 6A to 6C are views illustrating examples of a picture image captured when a camera apparatus such as, for example, the camera apparatus illustrated in FIG. 1 is in a non-fixed composition mode and a fixed composition mode according to an exemplary embodiment of the present invention.

Referring to FIGS. 6A to 6C, a capturing operation may be assumed to be performed by using the camera apparatus 100 included in the mobile communication terminal 500.

FIG. 6A illustrates a picture image captured when the mobile communication terminal 500 including the camera apparatus 100 maintains a horizontal mode. FIGS. 6B and 6C illustrate picture images 610 and 620 captured in a state in that the mobile communication terminal 500 including the camera apparatus 100 is slanted by θ°. Further, the picture image 610 of FIG. 6B corresponds to a picture image captured according to the non-fixed composition mode and the picture image 620 of FIG. 6C corresponds to a picture image captured according to the fixed composition mode.

As illustrated in FIG. 6A, in a picture image 601 formed by capturing an airplane 650, the airplane 650 is maintained in parallel to the ground in the picture image 601 and an underside of the picture image 601. In addition, in the camera apparatus 100 slanted by θ° that is illustrated in FIGS. 6B and 6C, the airplane 650 is parallel to the ground as in FIG. 6A.

The camera apparatus 100 of FIG. 6B is in a non-fixed composition mode so that a slanted angle of the camera apparatus 100 at the time of capturing (e.g.,) θ° is reflected in the picture image 610. Therefore, in the picture image 610 of FIG. 6B, the airplane 650 is still parallel to the ground in the picture image 610 but the airplane 650 is slanted by θ° with respect to the underside of the picture image 610.

Meanwhile, the camera apparatus 100 of FIG. 6C is in the fixed composition mode, so that a slanted angle of the camera apparatus 100 at the time of capturing (e.g., θ°) is not reflected in the picture image 620. Therefore, the airplane 650 in the picture image 620 of FIG. 6C is parallel to the ground in the picture image 620 and the underside of the picture image 620, as illustrated in FIG. 6A.

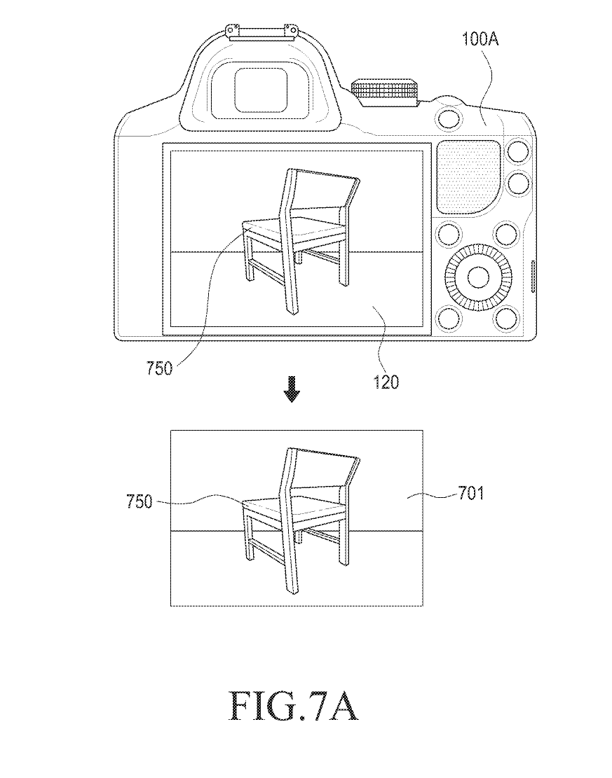

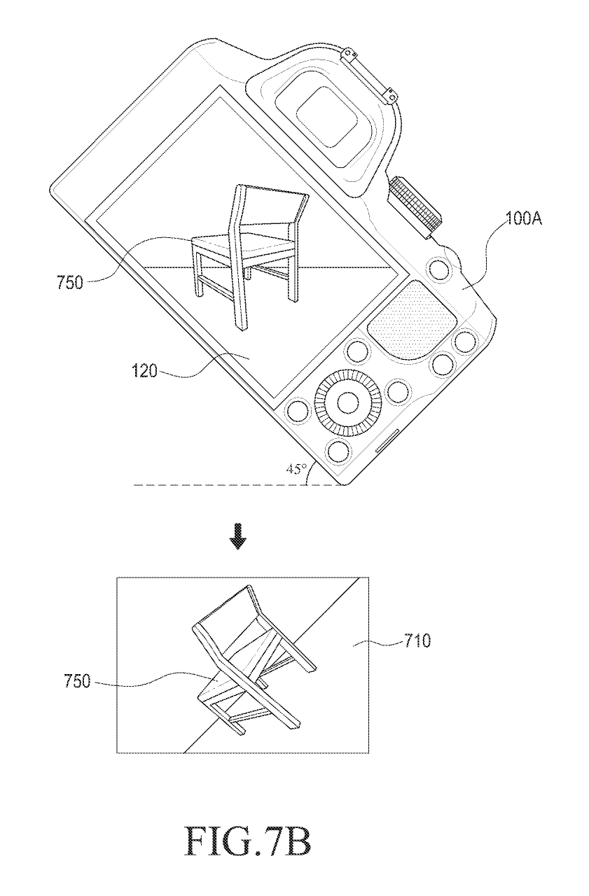

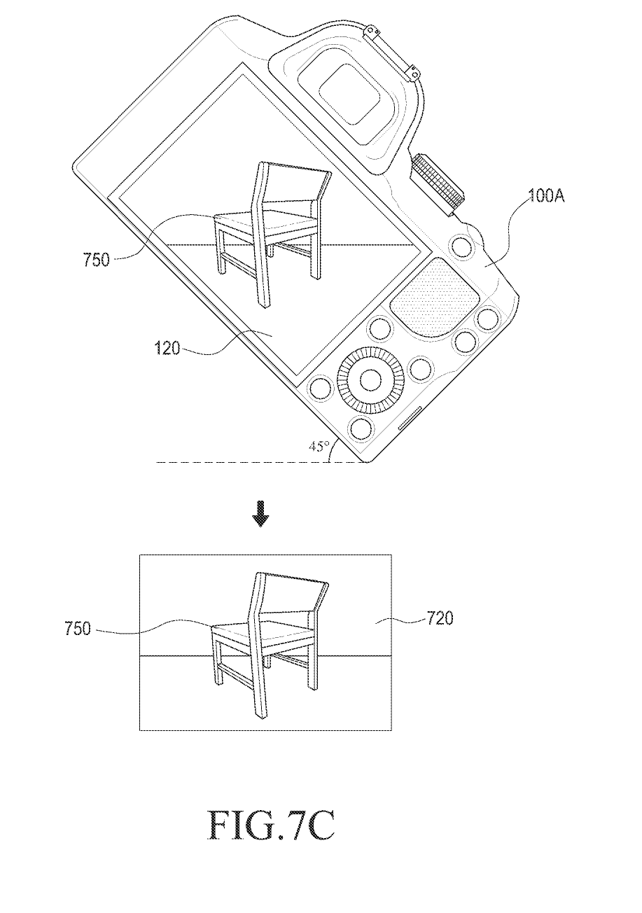

FIGS. 7A to 7C are views illustrating other examples of a picture image captured when a camera apparatus such as, for example, the camera apparatus illustrated in FIG. 1 is in a non-fixed composition mode and a fixed composition mode according to an exemplary embodiment of the present invention.

Referring to FIGS. 7A to 7C, the camera apparatus 100A corresponds to an example of the camera apparatus 100 according to the present invention.

FIG. 7A illustrates a picture image 701 captured when the camera apparatus 100A is kept parallel to the ground. FIG. 7B illustrates a picture image 710 captured when the camera apparatus 100A is slanted by 45° in a non-fixed composition mode. FIG. 7C illustrates a picture image 720 captured when the camera apparatus 100A is slanted by 45° in a fixed composition mode. Further, an image input through a lens may be displayed through a display unit 120 of the camera apparatus 100A.

As illustrated in FIG. 7A, a chair 750 displayed on the display unit 120 of the camera apparatus 100A is kept parallel to the underside of the display unit 120 and the chair 750 in the picture image 701 captured by the camera apparatus 100A is also kept parallel to the underside of the picture image 701.

As illustrated in FIG. 7B, the camera apparatus 100A of the non-fixed composition mode is slanted by 45° in a clockwise direction. In the state in which the camera apparatus 100A is slanted by 45°, the chair 750 displayed on the display unit 120 is kept parallel to the ground but is not parallel to the underside of the display unit 120. As shown in FIG. 7B, the chair 750 of the picture image 710 captured by the camera apparatus 100A slanted by 45° is also slanted by 45° in a counterclockwise direction with respect to the underside of the picture image 710. As described above, in the non-fixed composition mode, the composition of the captured picture image 710 changes according to the slope of the camera apparatus 100A.

As illustrated in FIG. 7C, the camera apparatus 100A of the non-fixed composition mode is also slanted by 45° in a clockwise direction. Therefore, the chair 750 displayed on the display unit 120 of the camera apparatus 100 is kept parallel to the ground but is not parallel to the underside of the display unit 120. However, because the camera apparatus 100A is in the fixed composition mode, the chair 750 in the picture image 720 captured by the camera apparatus 100 is parallel to the underside of the picture image 720. In the fixed composition mode as described above, it is possible to capture a picture image or a dynamic image having a constant composition without relation to the slope of the camera apparatus 100A.

According to the present invention, a camera apparatus for capturing a picture image or a dynamic image of a constant composition without relation to a slope of a camera apparatus and a capturing method thereof are provided.

It should be noted that a capturing method according to exemplary embodiments of the present invention may be implemented by hardware, software, or a combination of the hardware and the software. The software may be stored in a volatile or non-volatile storage device including a storage device such as a Read-Only Memory (ROM) or a memory such as a Random Access Memory (RAM), a memory chip, or an integrated circuit, and a storage medium such as a Compact Disk (CD), a DVD, a magnetic disk, or a magnetic tape which enables an optical or magnetic recording as well as being readable by a machine (for example, a computer). A capturing method according to an exemplary embodiment of the present invention may be implemented by a computer and a portable terminal including a controller and a memory and it should be understood that the memory is an example of a non-transient machine (e.g., a computer) readable storage medium suitable for storing a program or programs including instructions that implement exemplary embodiments of the present invention. Therefore, exemplary embodiments of the present invention includes a non-transient machine-readable storage medium which stores a program or programs including codes for implementing a method described by the appended claims. Also, such a program may be electrically transmitted through any medium similar to a communication signal which is propagated by wire or wirelessly, and the present invention includes equivalents thereof.

Further, the camera apparatus 100 may receive a program from a program providing apparatus which is wire/wirelessly connected thereto and thereafter store the program. The program providing apparatus may include a memory for storing a program including instructions allowing the camera apparatus 100 to perform a preset content protection method, information required for a contents protection method, or the like, a communication unit for performing a wired/wireless communication with the camera apparatus 100, and a controller for transmitting a corresponding program to the transmitting and receiving apparatus either in response to a request from the camera apparatus 100 or automatically.

While the invention has been shown and described with reference to certain exemplary embodiments therefore, it will be understood by those skilled in the art that various changes in form and details may be made therein without departing from the spirit and scope of the present invention may not be defined by the described embodiments but shall be defined by the spirit and scope of the appended claims.

What is claimed is:

1. A camera apparatus comprising:
a camera configured to receive an image input through a lens;
an image processor configured to convert the image into at least one of a picture image and a dynamic image; and
a controller configured to:
determine whether an operation mode of the camera apparatus corresponds to a fixed composition mode,
if the operation mode corresponds to the fixed composition mode, control the image processor to crop at least a part of the at least one of the picture image and the dynamic image so that the at least a part has a preset composition, and
control the image processor to store the at least a part of the at least one of the picture image and the dynamic image.

2. The camera apparatus of claim 1, wherein, when the operation mode does not correspond to the fixed composition mode, the controller controls the image processor to store the image input through the lens as the at least one of the picture image and the dynamic image without any change.

3. The camera apparatus of claim 2, wherein the controlling of the image processor to store the image input through the lens as at least one of the picture image and the dynamic image without any change corresponds to storing the image such that no portion of the image is cropped.

4. The camera apparatus of claim 2, wherein the controlling of the image processor to store the image input through the lens as at least one of the picture image and the dynamic image without any change corresponds to storing the image such that the image is not rotated.

5. The camera apparatus of claim 1, further comprising:
a user input unit for receiving a composition setting value from a user,
wherein, if the operation mode corresponds to the fixed composition mode, the image processor crops at least a part of at least one of the picture image and the dynamic image so that the at least a part has the preset composition by applying the composition setting value to the at least one of the picture image and the dynamic image.

6. The camera apparatus of claim 1, further comprising:
a sensor unit for measuring at least one of a rotation direction and a rotation angle of the camera apparatus,
wherein, if the operation mode corresponds to the fixed composition mode, the image processor rotates the at least one of the picture image and the dynamic image in a reverse direction by the at least one of the rotation direction and the rotation angle.

7. A capturing method of a camera apparatus, the capturing method comprising:
converting an image input through a lens into at least one of a picture image and a dynamic image;
determining whether an operation mode of the camera apparatus corresponds to a fixed composition mode;
if the operation mode corresponds to the fixed composition mode, cropping at least a part of the at least one of the picture image and the dynamic image so that the at least a part has a preset composition; and
storing the least a part of the least one of the picture image and the dynamic image.

8. The method of claim 7, further comprising:
if the operation mode does not correspond to the fixed composition mode, storing the image input through the lens as the at least one of the picture image and a dynamic image without any change.

9. The method of claim 8, wherein the storing of the image input through the lens as the at least one of the picture image and the dynamic image without any change corresponds to storing the image such that no portion of the image is cropped.

10. The method of claim 8, wherein the storing of the image input through the lens as the at least one of the picture image and the dynamic image without any change corresponds to storing the image such that the image is not rotated.

11. The method of claim 7, further comprising before converting the image input through the lens into the at least one of the picture image and the dynamic image:
receiving a composition setting value input by a user.

12. The method of claim 11, wherein the cropping of the at least a part of the at least one of the picture image and the dynamic image having the preset composition and storing the at least a part of the least one of the picture image and the dynamic image comprises:
cropping the at least a part of the least one of the picture image and the dynamic image so that the at least a part has the preset composition by applying the composition setting value to the least one of the picture image and the dynamic image.

13. The method of claim 7, further comprising before cropping the at least a part of the at least one of the picture image and dynamic image having the preset composition:
measuring at least one of a rotation direction and a rotation angle of the camera apparatus; and
rotating the at least one of the picture image and the dynamic image in a reverse direction by the rotation direction or the rotation angle.
